(19) United States
(12) Patent Application Publication
(10) Pub. No.: US 2017/0122417 A1
(43) Pub. Date: May 4, 2017

(54) DRIVE DEVICE FOR DRIVING A TOOL SLIDE IN A FOLDING SYSTEM

(71) Applicants: ThyssenKrupp System Engineering GmbH, Heilbronn (DE); ThyssenKrupp AG, Essen (DE)

(72) Inventor: Uwe Feis, Nohfelden (DE)

(73) Assignees: ThyssenKrupp System Engineering GmbH, Heilbronn (DE); ThyssenKrupp AG, Essen (DE)

(21) Appl. No.: 15/127,662

(22) PCT Filed: Mar. 18, 2015
(86) PCT No.: PCT/EP2015/055660

§ 371 Date: Sep. 20, 2016

(30) Foreign Application Priority Data
Mar. 20, 2014 (DE) 10 2014 103 827.4

(51) Int. Cl. F16H 25/14; F16H 53/06; B21D 39/02; F16H 53/02

(52) U.S. Cl. CPC F16H 25/14; F16H 53/02; F16H 53/06; B21D 39/021

(57) ABSTRACT

A drive device for driving a tool slide in a folding installation is proposed, wherein the drive device comprises a slide plate connected directly or indirectly to the tool slide, and a driveshaft that is rotatable about a rotation axis, wherein a rotary movement of the driveshaft is convertible by means of a cam disk into a linear movement, extending in the feed direction, of the slide plate.

### FIELD

The present invention relates to a drive device for driving a tool slide in a feed direction in a folding installation, and to a method for driving a tool slide.

### BACKGROUND

Such drives are used for example in industrial production plants in order to form semifinished products or components. In particular, the drive devices of the type in question are found in folding installations in which typically metal sheets are folded and in which a driven tool slide deforms the workpiece. In this type of bending, the precision with which the tool slide is driven is often a decisive factor for the quality of a folding operation. Folded components are often a component of external cladding or external sheathing. Therefore, their appearance—which is influenced by the quality of the folding operation—is often the reason for which, in folding operations, a standard that is as high as possible with regard to positional accuracy or positional reliability of the tool slide is demanded. Pneumatic or hydraulic cylinders by way of which the tool slide is driven, which are arranged in a plane with the workpiece and as a result take up a large amount of installation space are known as drive devices from the prior art. Furthermore, the drive devices from the prior art exhibit the problem that the workpiece is generally not prevented from executing an undesired movement in the opposite direction (to the feeding movement) or an undesired continued movement without further complexity. As a result, the positional accuracy during displacement is disadvantageously impaired.

### SUMMARY

It is an object of the present invention to provide a device with which a tool slide can be displaced in a folding installation in as positionally accurate a manner as possible with a simultaneously high cycle rate, i.e. a short cycle time. Here, it is desirable for the tool slide to remain substantially unimpaired in terms of its movement and positioning by movements acting counter thereto during folding in a simple and space-saving manner.

The object of the present invention is achieved by a drive device for driving a tool slide in a folding installation, wherein the drive device comprises a slide plate connected directly or indirectly to the tool slide, and a driveshaft that is rotatable about a rotation axis, wherein a rotary movement of the driveshaft is convertible by means of a cam disk into a linear movement, extending in the feed direction, of the slide plate.

The drive device according to the invention has the advantage of controlling the linear movement of the slide plate and thus of the tool slide via the driveshaft, wherein the linear movement is responsible for the formation, in particular folding, by the tool slide of a workpiece that is able to be placed in the folding installation. Furthermore, pneumatic and hydraulic cylinders are advantageously dispensed with, with the result that the cycle time can be reduced. In this case, the cam disk preferably additionally takes on the object of blocking the tool slide in the processing position, which would otherwise have to be realized by permanent maintenance of the pressure in the cylinder. In particular, the cam disk is positionable such that it directly or indirectly prevents a return movement of the tool slide when retroactions act on the tool slide on account of the folding process or other causes.

Preferably, the workpiece is a metal sheet which is formed for example into a hood for a motor vehicle. In this case, the workpiece interacts with the tool slide in a form-fitting manner in the feed direction during folding, the movement of said tool slide effecting the folding. Provision is furthermore made for the cam disk to be configured such that it acts temporarily as a force-flow means on the slide plate during rotation about the rotation axis and as a result either brings about the movement of the slide plate in the feed direction or the blocking in the processing position. The driveshaft in this case preferably exhibits a torque and an angular velocity. As a result of the cam disk acting as a force-flow means, the torque of the driveshaft is convertible into a force of the slide plate, and the angular velocity of the driveshaft is convertible into a translational velocity of the slide plate.

Advantageous configurations and developments of the invention can be gathered from the dependent claims, and from the description with reference to the drawings.

In a further embodiment, provision is made for the drive device to comprise an electric drive, preferably an electric motor, for the rotary movement of the driveshaft. As a result, the torque and the angular velocity of the driveshaft and thus also the linear movement of the slide plate can be controlled in a particularly simple and precise manner.

In a further embodiment, provision is made for the rotation axis to extend substantially perpendicularly to the feed direction. As a result, a device used for driving the driveshaft can be arranged advantageously in a space-saving manner above or beneath the plane along which the tool slide is moved.

In a further embodiment, provision is made for the driveshaft to be connected to the cam disk in a coupling region so as to rotate with said cam disk, wherein the coupling region is arranged eccentrically on the cam disk. As a result of the eccentric positioning of the coupling region, a stroke path, i.e. the distance covered by the slide plate while being pushed forward, can advantageously be defined. It is in this case conceivable for the cam disk to comprise a slot, wherein the driveshaft is guidable continuously along the slot and is fixable at a desired point. As a result, it is easy for an eccentricity of the positioning of the coupling region to be changed and thus for the stroke path to be adapted.

In a further embodiment, provision is made for the slide plate to comprise a guide block, wherein the guide block is arranged at least temporarily in a form-fitting manner with respect to the cam disk in the feed direction. In this case, it is conceivable for the cam disk to interact with the cam disk multiple times or permanently in a form-fitting manner during a rotation of the drive shaft. Preferably, the guide block and the cam disk interact in a form-fitting manner at the time at which the tool slide has taken up a folding position. As a result, the tool slide can be easily and advantageously prevented from leaving the desired, in particular intended folding position again as a result of a movement counter to the feed direction. In other words, the tool slide is blocked in the processing position. In particular, provision is made for the cam disk to be configured such that, during a rotation, said blocking is synchronized with other processes in the folding installation, for example the delivery and discharging of the workpiece.

In a further embodiment, provision is made for the slide plate to comprise a further guide block, wherein the further guide block is arranged at least temporarily in a form-fitting manner with respect to the cam disk in a direction opposite to the feed direction. In particular, the guide block and the further guide block are arranged along a connecting line, wherein the connecting line extends substantially parallel to the feed direction.

In a further embodiment, provision is made for the guide block and/or the further guide block to comprise a cam roller, wherein the cam roller is rotatable about an axis extending parallel to the rotation axis and is able to be brought at least temporarily into contact with the cam disk. As a result of the cam roller, the guide block can roll at least temporarily along the cam disk. This advantageously reduces the possibility of tilting and at the same time reduces wear phenomena that occur on the guide slot and are brought about by the continual rubbing against one another.

In a further embodiment, provision is made for the guide block and/or the further guide block to be preloaded such that the contact between the cam disk and the guide block and/or the further guide block during a rotation of the cam disk is maintained during the rotation of the driveshaft. A prerequisite is that the guide block is displaceable along the connecting line relative to the further guide block. For example, the further guide block is integrated into the slide plate in a displaceable manner. During the rotation of the cam disk, the distance between the guide block and the further guide block then changes. As a result of the maintaining of the contact, the positional accuracy during the movement of the slide plate is further improved.

In a further embodiment, provision is made for a curved profile of the cam disk to determine the driving of the tool slide in the feed direction. In this case, the curved profile is understood to mean the circumferential profile of the cam disk in a direction extending perpendicularly to the rotation axis. In particular, velocity profiles can be realized or determined during the linear movement of the slide plate by a particular curvature of the curved profile. Provision is made here for the curvature of the curved profile to be adapted optimally to the manufacturing process of the particular workpiece, in particular to the particular folding process.

In a further embodiment, provision is made for the curved profile of the cam disk
to determine at least one fixed position of the slide plate, and/or
to comprise a first circular subsegment with a first radius and a second circular subsegment with a second radius, wherein the second radius is greater than the first radius. Preferably, there are up to four fixed positions. In a fixed position, the slide plate is not moved by the flow of force coming from the cam disk. It is conceivable here for the cam disk to be configured such that, although it is arranged in a form-fitting manner with respect to a part of the slide plate, preferably with respect to the guide block, at a particular rotary position, it does not exert any force on the slide plate. In such a rotary position, the drive device is advantageously also suitable for preventing undesired movements of the workpiece. Furthermore, the movement of the slide plate and thus of the tool slide can advantageously be accelerated by a first circular subsegment, the first radius of which is smaller than the second radius.

In a further embodiment, provision is made for the slide plate to comprise an adapter for a multiplicity of different tool slides. Preferably, depending on the component to be folded, it is possible to change between the different tool slides. In particular, the tool slide can be adapted to the particular type of component. As a result, many different components can be folded in a folding installation under certain circumstances.

In a further embodiment, provision is made for
the slide plate and/or the cam disk to be interchangeable, and/or for
a protective means to be arranged between the slide plate and cam disk. As a result, the multiplicity of possible components can be increased even further. In particular, a multiplicity of components with different dimensions can be folded by way of the same folding installation by easy selection of the drive device having the correct slide plate and/or the correct cam disk. Furthermore, it is conceivable, in order to increase the lifetime of the drive device, for a protective means, for example a guide roller exhibiting an oil film or rubber material, to be arranged between the slide plate and the cam disk.

In a further embodiment, provision is made for the tool slide to be a folding-jaw carrier. Preferably, the tool slide comprises a folding-jaw carrier and a base part, wherein the folding-jaw carrier is linearly movable relative to the base part. In particular, provision is made here for a folding-jaw drive for effecting a linear movement of the folding-jaw carrier relative to the base part to be fastened to the folding-jaw carrier, or for a folding-jaw drive having a drive direction oriented at an angle to the linear movement in order to effect a linear movement of the folding-jaw carrier relative to the base part to be fastened to the base part.

A further subject of the present invention is a folding installation having a drive device as described above. With such a folding installation, metal sheets can be folded in an advantageous manner at a very short cycle time, wherein the drive device ensures the necessary positional accuracy for positioning the tool slide.

A further subject of the present invention is a method for driving a tool slide in a feed direction in a folding installation, wherein a rotary movement of a driveshaft is converted by means of a cam disk into a linear movement of a slide plate, which is connected directly or indirectly to the tool slide, in the feed direction.

Compared with the prior art, it is advantageously possible to dispense with pneumatic or hydraulic cylinders here. Instead, it is conceivable for the driveshaft to be driven by an electric drive, preferably an electric motor, for rotation. By way of the electric drive, the movement of the component can advantageously be controlled in an uncomplicated manner. In particular, it is conceivable for the electric drive to be coupled to a control loop, with the aid of which it is possible to immediately react to changes in the manufacturing process.

In a further embodiment, provision is made for a drive device as described above to be used for driving the tool slide.

Further details, features and advantages of the invention can be gathered from the drawings and from the following description of preferred embodiments with reference to the drawings. In this case, the drawings illustrate only exemplary embodiments of the invention which do not limit the essential concept of the invention.

### BRIEF DESCRIPTION OF THE FIGURES

FIG. 1 shows a folding installation having a drive device according to a first exemplary embodiment of the present invention.

FIG. 2 shows the drive device according to the first exemplary embodiment of the present invention in a perspective view.

FIG. 3 shows the drive device according to the first exemplary embodiment of the present invention in an exploded illustration.

FIG. 4 shows a cam disk for a drive device according to the present invention.

### DETAILED DESCRIPTION

In the various figures, identical parts are always provided with the same reference signs and are therefore generally also mentioned only once in each case.

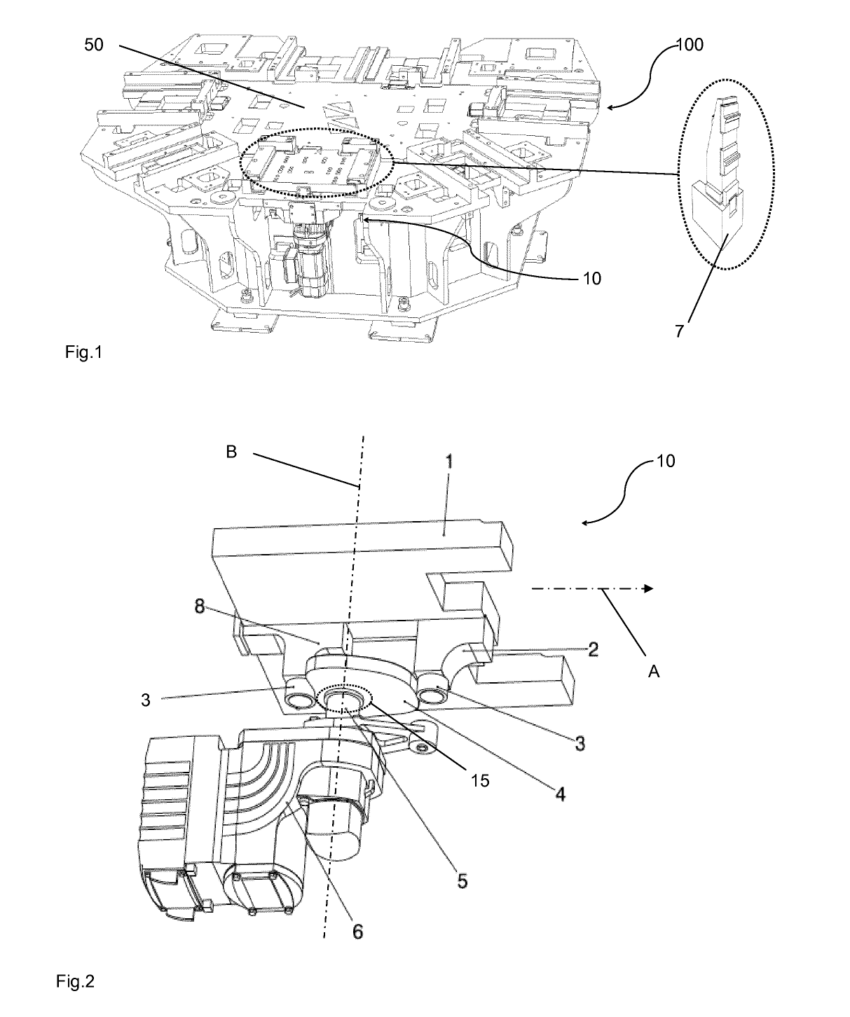

FIG. 1 illustrates a folding installation 100 in which a drive device 10 according to a first exemplary embodiment of the present invention is illustrated. Such folding installations place high requirements on the drive device 10 when a large number of forming operations, in particular folding processes, need to be realized in as time-saving a manner as possible. Provision is made here for a component, for example a plate, from which a hood is intended to be manufactured, to be placed on a receiving surface 50. Preferably, there are two components which are intended to be connected by the folding operation and of which one of the components has already been preformed. For example, it is conceivable for a first component to be at least partially bent at the periphery and for the bent part of the first component to extend at least partially perpendicularly to the receiving surface. Preferably, the second component is arranged on the first component and, by way of the folding process, the first component is bent further, or flanged, such that it at least partially covers the second component. For the folding process, a tool slide 7 is provided, which is illustrated in an enlarged manner in FIG. 1 and is connected directly or indirectly to a slide plate 1. In this case, the tool slide 7 comes into contact with the component during the folding process and folds the latter. With the aid of the movable slide plate 1, the folding process can then take place in the folding installation 100 in that the slide plate and thus also the tool slide 7 is moved in the direction of the component. In particular, provision is made for the slide plate 1 to be driven by the drive device 10. Preferably, the drive device 10 comprises a motor, in particular an electric motor 6, which is arranged beneath the plane in which the slide plate 1 is moved for the folding process.

FIG. 2 illustrates the drive device 10 according to a first exemplary embodiment of the present invention. The drive device 10 comprises a slide plate 1 and a driveshaft 5. Provision is made here for the slide plate 1 to be used to drive a tool slide 7, as illustrated in FIG. 1, wherein the tool slide 7 in turn interacts directly or indirectly in a form-fitting manner with the component in the feed direction A and as a result brings about the forming thereof. It is conceivable for the slide plate 1 to comprise an adapter on which a wide variety of tool slides 7 are arrangeable depending on the component to be folded. Furthermore, provision is made for the driveshaft 5 and the slide plate 1 to be operatively connected via a cam disk 4. In particular, the cam disk 4 acts as a force-flow means which converts a rotary movement of the driveshaft 5 about a rotation axis B into a linear movement of the slide plate 1 in the feed direction A. It is thus advantageously possible to configure the drive device in a space-saving manner because it is advantageously possible to dispense with bulky pneumatic cylinders which would otherwise have to be arranged in the plane in which the slide movement for the folding process takes place.

In the first exemplary embodiment, the driveshaft 5 for converting the rotary movement into a linear movement is connected to the cam disk 4 in a coupling region 15 so as to rotate with said cam disk 4, wherein the coupling region 15 is arranged eccentrically on the cam disk 4. Furthermore, provision is made for the slide plate 1 to comprise a guide block 2 and/or a further guide block 8. In particular, the guide block 2 and the further guide block 8 are arranged along a connecting line, wherein the connecting line extends substantially parallel to the feed direction A. Preferably, the guide block 2 and/or the further guide block 8 each comprise a cam roller 7 which is configured such that it rolls at least in portions along the curved profile, i.e. along a circumference of the cam disk 4 in a plane extending perpendicularly to the rotation axis B.

Furthermore, provision is made for the cam disk 4 to be arranged in a form-fitting manner with respect to the guide block 2 and with respect to the further guide block 8 in at least one rotary position of the cam disk. The guide block 2, the cam disk 4 and the further guide block 8 are then arranged immediately adjacently to one another, in particular in contact with one another, in a row. In such a situation, the slide plate 1 is secured in its position, in particular with respect to movements counter to the feed movement, by the form fit with the guide block 2 and the further guide block 8, i.e. an undesired offset of the slide plate 2 and thus of the tool slide 7 is prevented. Preferably, the rotary position is taken up when the tool slide 7 has taken up its target position. It is in this case conceivable for the cam roller 7 to be equipped with a rubber-like material as protective means. During a rotation of the cam disk 4, the guide block 2 or the further guide block 8 is—in a manner determined by the curved profile 19—pushed in a feed direction A or in a direction counter to the feed direction A. The guide block 2 or further guide block 8 that is moved as a result and thus the slide plate 1 are consequently moved in the feed direction A.

It is furthermore conceivable for the cam disk 4 to be configured such that, during the rotation of the driveshaft 5, the contact between the cam disk 4 and the guide block 2 or the further guide block 8 is at least temporarily released. If contact has been released, the cam disk 4 cannot drive the slide plate 1 and thus also the tool slide, and preferably takes up a position in which the component is not subjected to a force. In particular, contact is released when the cam disk 4 takes up a position in which the extent of the cam disk 4 between the guide block 2 and the further guide block 8 is smaller than the distance between this very guide block 2 and the further guide block 8. Furthermore, provision is made for the curved profile 19 of the cam disk 4 to specify or determine a movement pattern of the slide plate 1. The movement pattern is in this case described substantially by the velocity at which a feed movement of the slide plate 1 takes place. By way of the movement pattern, the cycle rate at which the forming process, in particular the folding, takes place is substantially codetermined. In this case, the curved profile 19 determines how a rotary movement coming from the driveshaft 5 and an angular velocity are converted. Furthermore, provision is made for the driveshaft 5 to be driven by an electric drive 6, preferably an electric motor. As a result, the torque and angular velocity of the driveshaft 5 and consequently also the cycle rate of the forming process, in particular the folding operation, is advantageously controllable.

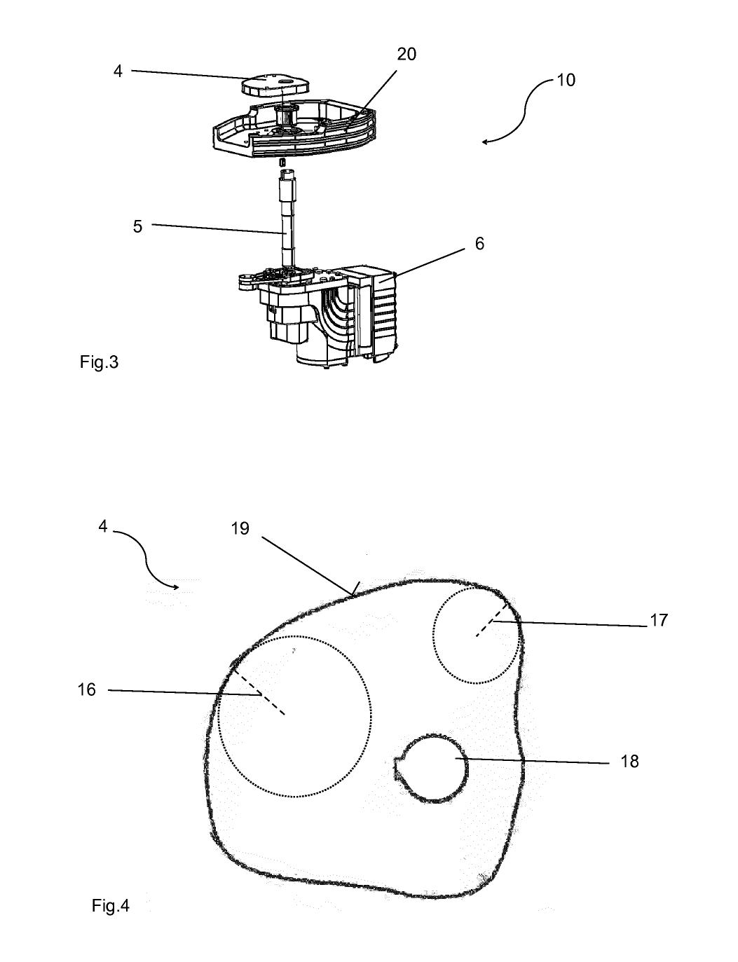

FIG. 3 shows the drive device 10 according to the first exemplary embodiment of the present invention in an exploded illustration. In order to protect the cam disk 4, the drive device 10 preferably comprises a collar 20. The collar 20 at least partially encloses the cam disk 4 and comprises, on its side pointing towards the slide plate, an opening via which the cam disk 4 can come into direct or indirect contact with the slide plate 1.

FIG. 4 shows a cam disk 4 for a drive device 10 according to the present invention. Provision is made here for the curved profile 19 to determine the velocity at which the slide plate 1 is moved. In particular, the curved profile 19 comprises circular subsegments, the radii of which are decisive for the velocity of the slide plate 1. For example, the curved profile 19 comprises a first circular subsegment with a first radius 16 and a second circular subsegment with a second radius 17, wherein the first radius 16 is greater than the second radius 17. If the guide block 2 is currently in contact with the first subsegment, the slide plate 1 is driven at a slower velocity than when the guide block 2 is currently in contact with the second subsegment. Preferably, the driveshaft 5 is arrangeable in a corresponding cutout 18 in the cam disk 4.

### LIST OF REFERENCE SIGNS

1 Slide plate

2 Guide block

3 Cam roller

4 Cam disk

5 Driveshaft

6 Electric drive

8 Further guide block

10 Drive device

12 Processing device

15 Coupling region

16 First radius

17 Second radius

18 Cutout for driveshaft

19 Curved profile °Collar

50 Receiving surface for the component

100 Manufacturing installation

A Feed direction

B Rotation axis

1. A drive device for driving a tool slide in a folding installation, the drive device comprising:
a slide plate connected to the tool slide; and
a driveshaft that is rotatable about a rotation axis (B);
wherein a rotary movement of the driveshaft is convertible by means of a cam disk into a linear movement, extending in a feed direction, of the slide plate.

2. The drive device as claimed in claim 1, wherein the drive device comprises an electric drive for the rotary movement of the driveshaft.

3. The drive device of claim 2, wherein the rotation axis (B) extends substantially perpendicularly to the feed direction (A).

4. The drive device of claim 3, wherein the driveshaft is connected to the cam disk in a coupling region so as to rotate with said cam disk, wherein the coupling region is arranged eccentrically on the cam disk.

5. The drive device of claim 1, wherein the slide plate comprises a guide block, wherein the guide block is arranged at least temporarily in a form-fitting manner with respect to the cam disk in the feed direction (A).

6. The drive device of claim 5, wherein the slide plate comprises a further guide block, wherein the further guide block is arranged at least temporarily in a form-fitting manner with respect to the cam disk in a direction opposite to the feed direction.

7. The drive device of claim 6, wherein at least one of the guide block and the further guide block comprises a cam roller, wherein the cam roller is rotatable about an axis extending parallel to the rotation axis (B) and is able to be brought at least temporarily into contact with the cam disk.

8. The drive device of claim 7, wherein the guide block and/or the further guide block are preloaded such that the contact between the cam disk and at least one of the guide block and the further guide block during a rotation of the cam disk is maintained during a rotation of the cam disk.

9. The drive device of claim 1 wherein the cam disk has a curved profile that determines the movement of the tool slide in the feed direction.

10. The drive device of claim 9, wherein the curved profile of the cam disk
determines at least one fixed position of the slide plate, and
comprises a first circular subsegment with a first radius and a second circular subsegment with a second radius, wherein the second radius is greater than the first radius.

11. The drive device of claim 1, wherein the slide plate comprises an adapter for a multiplicity of different tool slides.

12. The drive device of claim 1, wherein
the slide plate and the cam disk are interchangeable; and
a protective means is arranged between the slide plate and cam disk.

13. The drive device of claim 1, wherein the tool slide is a folding-jaw carrier.

14. A folding installation comprising:
a drive device for driving a tool slide and having a slide plate connected to the tool slide; and
a driveshaft that is rotatable about a rotation axis (B);
wherein a rotary movement of the driveshaft is convertible by means of a cam disk into a linear movement, extending in a feed direction, of the slide plate.

15. A method for driving a tool slide in a feed direction (A) in a folding installation, wherein a rotary movement of a driveshaft is converted by means of a cam disk into a linear movement of a slide plate, which is connected to the tool slide, in the feed direction (A).

16. The method as claimed in claim 15, further comprising:
rotating the driveshaft about a rotation axis that extends substantially perpendicularly to the feed direction.
